(19) United States
(12) Patent Application Publication
(10) Pub. No.: US 2007/0166132 A1
(43) Pub. Date: Jul. 19, 2007

(54) Load Transport Device

(76) Inventor: Marcel COUTURE, Debden (CA)

Correspondence Address: ADE & COMPANY INC., 2157 Henderson Highway, WINNIPEG, MB, R2G1P9, US

(21) Appl. No.: 11/623,198

(22) Filed: Jan. 15, 2007

(30) Foreign Application Priority Data
Jan. 16, 2006 (CA) 2534161

(51) Int. Cl. A01D 90/08; B65G 65/34

(52) U.S. Cl. 414/111; 414/409; 414/555

(57) ABSTRACT

A load transport device includes a deck suitable for supporting large square agricultural bales thereon. Side portions extending along opposing longitudinal sides of the deck are supported for movement relative to one another in a lateral direction so that a horizontal spacing therebetween is adjustable to accommodate various load sizes. A clamping force can be applied to the side portions for urging the side portions towards one another to clamp a load between the side portions for safe highway transport.

This application claims foreign priority benefits from Canadian Patent Application No. 2,534,161, filed Jan. 16, 2006.

### FIELD OF THE INVENTION

The present invention relates to a transport device for transporting loads supported thereon, and more particularly relates to a transport device having a deck which is suitable for supporting large square bales thereon.

### BACKGROUND

In the field of agriculture, when transporting large square bales it is known to make use of trucks or trailers having an elongate flat deck upon which the bales are stacked. Securement of the bales to the deck requires an operator to extend straps over the load. Strapping the bales is a time consuming task which can require one or two hours of labour in some instances. Furthermore strapping a load requires an operator to climb over the top of the load to properly position the straps. Due to the instability of the load and the height of typical loads, this can be a dangerous task as an operator falling from the top of the load is likely to suffer serious injury.

U.S. Pat. No. 4,498,829 to Spikes, U.S. Pat. No. 5,813,814 to Smart; U.S. Pat. No. 4,619,570 to Siebenga and U.S. Pat. No. 6,079,926 to Cox et al disclose various examples of vehicles for handling bales in which a flat deck is provided upon which the bales are stacked. Each document discloses an example of grapples on opposing sides of the deck to assist in maintaining the bales in a stacked configuration while pivoting the deck through 90° to place the stacked bales in an upright orientation on the ground. In general, the prior art grapples are limited to only grabbing a couple of bales or a designated row of bales to maintain the overall orientation of the bales relative to the deck during unloading. None however are particularly suited for securing all of the bales in an adequate manner during transport. Furthermore, the grapples of the prior art all rely on members which are pivoted at opposing sides of the deck at a fixed pivot location so that an overall lateral spacing between the opposing grapples is fixed for accommodating a set number or size of bales.

### SUMMARY OF THE INVENTION

According to one aspect of the invention there is provided a load transport device comprising:

a deck which is elongate in a longitudinal direction and which is supported for rolling movement along the ground in the longitudinal direction;

side portions extending in the longitudinal direction in an upright orientation along opposing sides of the deck, the side portions being supported for movement relative to one another in a lateral direction, transversely to the longitudinal direction of the deck such that a horizontal spacing between the side portions is adjustable to accommodate various load sizes; and

an actuator for applying a clamping force to the side portions to urge the side portions towards one another for clamping a load between the side portions.

According to another aspect of the present invention, the side portions and the actuator may be provided as a kit for attachment to an existing truck or trailer deck. In the instance of a kit for mounting on an existing deck, the components which support the side portions for lateral movement are preferably mounted above the existing deck.

The use of side portions which are supported for movement in a lateral direction prevents the horizontal spacing between the side portions to be adjusted for accommodating various load sizes unlike any of the prior art devices relating to transport devices for bales. By extending the side portions in the longitudinal direction along opposing sides of the deck, all of the bales along the length of the deck can be gripped between the opposing side portions for adequate securement during transport. The clamping force provided by the actuator ensures that bales are gripped between the side portions in a safe and convenient manner to eliminate the time consuming and dangerous task of strapping a load.

Preferably the side portions remain in a substantially vertical orientation as they are displaced in the lateral direction in a substantially horizontal sliding movement by telescoping members. A horizontal spacing between the side portions at a height of the deck may thus be adjusted along a length of the side portions in the longitudinal direction as the side portions are displaced in the lateral direction relative to one another.

When the deck comprises a flat deck, the side portions are preferably movable in a horizontal direction relative to the deck.

The side portions may include an upper supporting surface in substantially horizontal alignment with the deck in which the supporting surfaces of the side portion are movable relative to one another with the respective side portions.

There may be provided an adjustable spacing limiter on one of the side portions which only restricts movement of the respective side portion outwardly away from the deck.

Each side portion preferably comprises a plurality of posts spaced in the longitudinal direction and being commonly movable in the lateral direction.

The posts along at least one side portion are preferably selectively removable to assist in loading the deck.

The posts along one side portion may be supported for selected pivotal movement in addition to being slidable in the lateral direction.

Each side portion may comprise a plurality of sections which are movable independently of one another but which are commonly urged inwardly by the actuator.

An upright base plate may span between the posts along a bottom end thereof.

Preferably each post includes a plurality of cleats supported at vertically spaced positions thereon wherein the cleats are pivotal between an engaged position projecting laterally inwardly and a released position extending alongside the respective post.

Each cleat preferably includes an actuator associated therewith which is arranged to apply a downward clamping force to the cleat.

Each cleat may further include a broad engaging surface spanning generally in the longitudinal direction of the deck and which tapers inwardly towards an apex at a free end of the cleat.

The cleats may be biased into the engaged position and are pivotal in an upward direction from the engaged position to the released position.

There may be provided a plurality of rear posts extending upwardly from one end of the deck in which the rear posts are selectively removable.

The actuator may comprise a hydraulic actuator which maintains a clamping force by maintaining hydraulic pressure acting to urge the side portions laterally inward toward one another.

The actuator may further comprise a winch winding a cable thereon in which the cable is woven in alternating pattern between pulleys on opposing side portions for displacing the side portions towards one another in the lateral direction as the cable is shortened by winding on the winch.

The deck preferably comprises a flat deck of a trailer supported on wheels at a rear end and including a towing attachment at a front end for connection to a towing vehicle.

The trailer is particularly well suited for supporting a plurality of large square agricultural bales stacked thereon. In this instance, the horizontal spacing between the side portions is preferably adjustable through a range comprising approximately 8 feet to 12 feet.

One embodiment of the invention will now be described in conjunction with the accompanying drawings in which:

### BRIEF DESCRIPTION OF THE DRAWINGS

FIG. 1 is a side elevational view of the load transport device.

FIG. 2 is a top plan view of the device.

FIG. 3 is an end elevational view of the device.

FIG. 4 is a perspective view of one of the posts shown on the left hand side of FIG. 3.

FIG. 5 is a top plan view of the post according to FIG. 4.

FIG. 6 is a perspective view of one of the support arms supporting the side portion on the right hand side of FIG. 3.

FIG. 7 is a perspective view of a cleat on a portion of one of the posts.

FIG. 8 is a perspective view of an alternative embodiment of two opposed sections of the trailer side portions.

FIG. 9 is an enlarged perspective view of an upper free end of one of the posts according to the side sections of FIG. 8.

FIG. 10 and FIG. 11 are respective front elevational and top plan views of the two opposed sections of FIG. 8.

FIG. 12 is a top plan view of an alternative embodiment of a cleat according to the posts of FIG. 8.

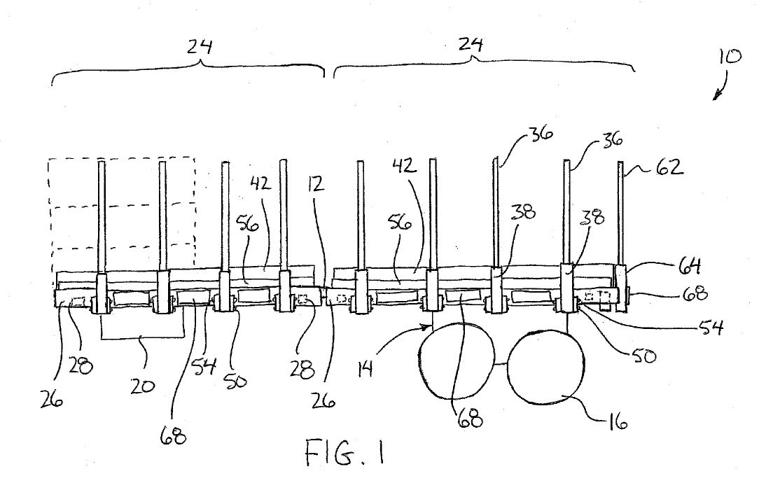

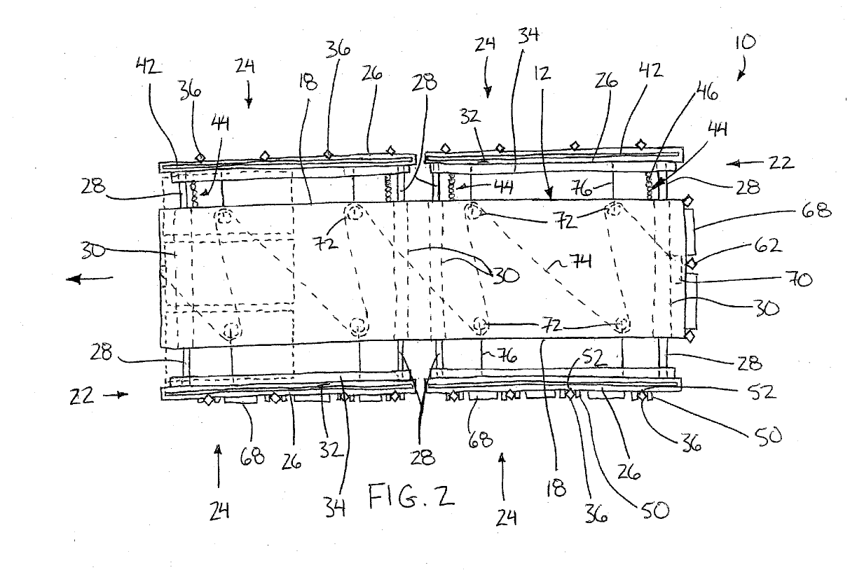

In the drawings like characters of reference indicate corresponding parts in the different figures.

### DETAILED DESCRIPTION

Referring to the accompanying figures there is illustrated a load transport device generally indicated by reference numeral 10. The device 10 is particularly suited for supporting large square bales thereon, for example agricultural bales in the order of 4 feet by 4 feet by 8 feet. The device 10 is arranged to secure the bales thereon for highway transport.

The transport device 10 generally comprises a trailer for towing behind a suitable highway truck tractor. A deck 12 is provided which is supported on a base frame 14 for rolling movement on respective wheels 16 at a rear end thereof. The deck 12 includes a flat top side in the form of a supporting surface upon which the load can be supported. The deck is elongate in a longitudinal direction of the device, including two longitudinally extending opposing sides 18. The wheels 16 support the deck for rolling movement along the ground in the longitudinal direction thereof. A towing attachment 20 is provided on a base frame 14 at the front end for connection to the towing vehicle.

The device further includes two side portions 22 which extend along the opposing longitudinal sides 18 of the deck respectively in the longitudinal direction. The side portions 22 are supported to be movable relative to the deck and relative to one another for displacement toward and away from one another in a horizontal and lateral direction perpendicular to the forward longitudinal direction. The horizontal spacing between the side portions 22 is thus adjustable for clamping loads of various sizes therebetween.

Each side portion is formed in two sections 24 in which each section includes a beam 26 extending in the longitudinal direction a full length of the respective section. Each beam 26 is joined to the deck by two telescoping support arms 28. The support arms are welded to the beam perpendicularly to the longitudinal direction and spaced longitudinally from one another towards opposing ends of the beam. Each support arm 28 is slidably received within a respective end of a mounting sleeve 30 fixed below the deck 12. Each support arm 28 is received within the same sleeve 30 as the corresponding support arm 28 of the opposing side portion so that the support arms are arranged in pairs received within opposing ends of each sleeve 30. The beams 26 are thus supported for sliding movement in the lateral direction by telescoping action of the support arms 28 within the respective sleeves 30.

The thickness of each beam 26 in the vertical direction is approximately equal to the combined thickness of the deck and the support arms 28 with the support arms being mounted near the bottom side of the beam. Accordingly a top side of the beam defines a supporting surface 32 which is substantially flush with the top side of the deck 12. Each beam further includes a lateral extension plate 34 secured to the top side thereof to project laterally inwardly towards the deck. The plate 34 is fixed to the beam for lateral sliding movement therewith while being mounted just above the deck 12 in elevation so that the extension plate 34 slides overtop of the deck when the beam is positioned directly against the respective side 18 of the deck.

A plurality of posts 36 are mounted at longitudinally spaced positions along each beam to extend upward in a vertical orientation therefrom. Each post 36 extends the height of plural stacked bales with spacing between the adjacent posts being equal to approximately half of the length of the bales so that at least two posts overlap each bale. In the illustrated embodiment, the posts have a four foot spacing for overlapping the eight foot length of the bales in pairs while the overall height of the posts is near twelve feet to accommodate three stacked bales having a thickness of four feet. The posts have a square cross section which is oriented on the diagonal relative to the longitudinal direction so that the interior surface of each post is defined by a corner edge for best gripping the bales.

The posts 36 are secured to the beams for sliding movement therewith relative to the deck at the height of the deck. The posts remain vertical throughout their sliding movement in the lateral direction relative to the deck so that spacing between the opposing side portions is adjustable throughout the full height of the posts from the mounting of the posts at the deck height to the upper free end thereof.

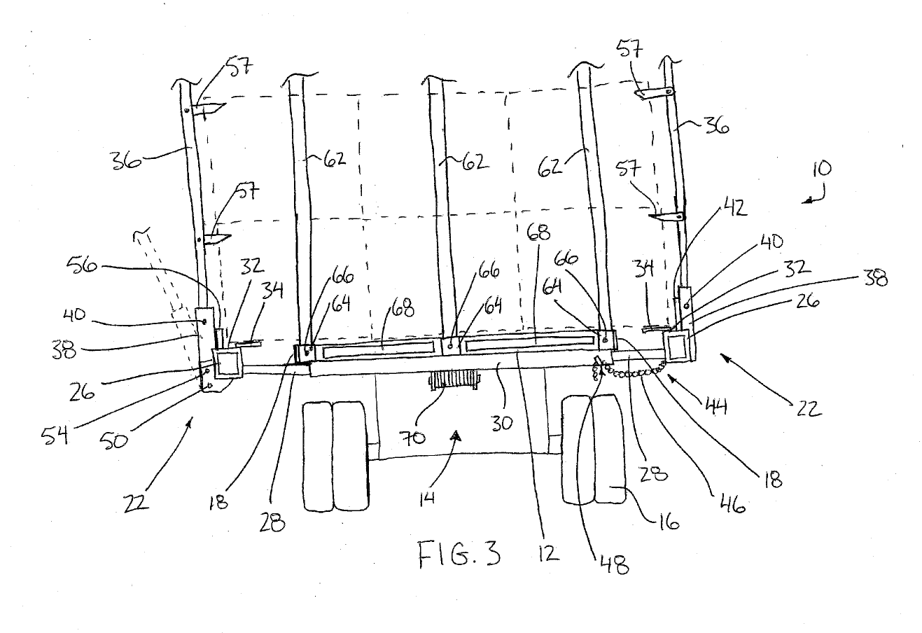

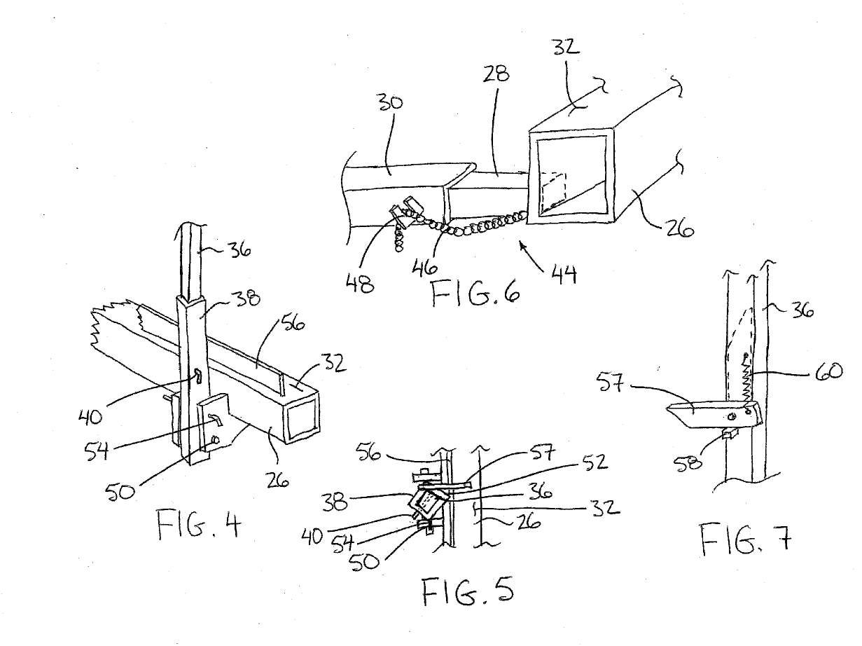

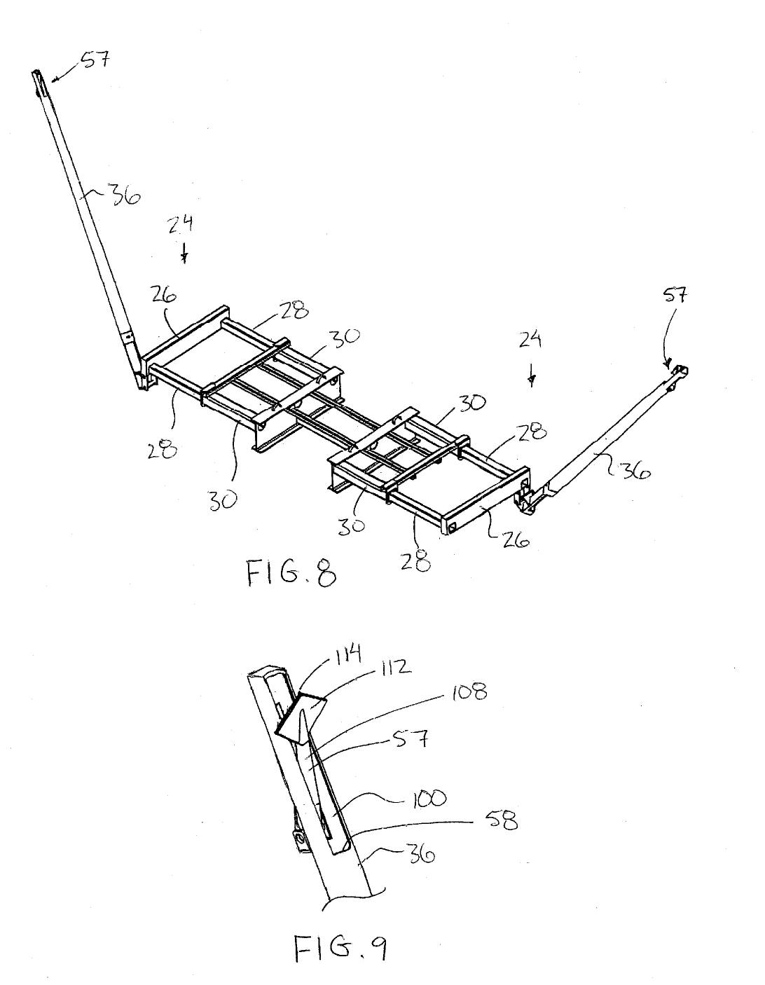

When viewed from the rear as shown in FIG. 3, the posts 36 on the right hand side are received within respective mounting sleeves 38 having a mating square cross section within which the post fits. A suitable locking pin 40 is provided for insertion through cooperating apertures in the post and sleeve for selectively locking the post within the sleeve. The sleeves 38 are welded to the respective beams 26 on the right hand side by being received within respective notches 52 in the beam at the outer side thereof. In this manner the inner side of each post which engages the load is spaced slightly inwardly from the outer side of the beam supporting the posts thereon.

A base plate 42 is provided on the beams 26 on the right hand side to extend in the longitudinal direction in a vertical upright orientation along the inner side of the mounting sleeves 38. In this manner the base plate 42 is continuous along the beam spaced inwardly from the inner side so that a sufficient portion of the upper supporting surface of the beam remains exposed at the inner side for supporting a portion of the load thereon. The base plate 42 on the right hand side has a height in the order of approximately 8 inches in the preferred embodiment so as to overlap the load sufficiently that when a bale is pushed from the left hand side to the right hand side it engages the base plate and acts to push the corresponding side portion laterally outwardly during loading.

A spacing limiter 44 is coupled between each beam and the deck to limit the horizontal spacing therebetween. This spacing limiter 44 on each beam comprises a pair of chains 46 which are each secured to the beam at a respective end of the beam by fixed welding. The opposing end of the chain 46 is adjustably secured to the deck. A latching slot 48 is provided at the outer end of each mounting sleeve 30 beneath the deck in which the slot 48 is inclined upwardly and inwardly to an open end of the slot for receiving the chain therein. The slot thus extends away from the beam to ensure that an outward force on the beam acts to pull the chain into the slot and prevent further displacement of both the chain and the beam away from the deck once the chain is received in the slot. The slot has a suitable width to permit the passage of only one link so that the overall spacing between the beam and the deck can be adjusted by selecting which link is received within the slot 48 at each spacing limiter 44 along the length of the side portion. The flexible nature of the chain only limits movement of the beam away from the deck but readily permits the beam to be displaced inwardly and does not interfere with a clamping force which urges the beam inwardly.

At the left hand side of FIG. 3, the posts 36 are similarly received within respective mounting sleeves 38 of mating cross section. The sleeves receive locking pins 42 which selectively secure the posts within the sleeve for later removal of the post as desired. The mounting posts 38 on the left hand side differ from the right hand side in that each sleeve is pivotally secured to the respective beam by respective pivot mounts 50 which support the mounting sleeves for pivotal movement about respective horizontal axes commonly aligned with one another in the longitudinal direction spaced outwardly and below the respective beam.

An outer side of the beam includes notches 52 therein similarly to the right hand side for receiving a portion of the cross section of the mounting sleeve 38 therein when the posts are pivoted into an upright vertical orientation. Location of the pivot axis relative to the beam ensures that the posts cannot be pivoted inwardly towards the deck beyond a vertical orientation. In the vertical orientation a suitable locking pin 54 is received through cooperating apertures in the pivot mount 50 and the mounting sleeve to secure the post in the vertical orientation. When the pin is released, the post is permitted to swing laterally outwardly at the upper end thereof to the outermost position shown in broken line in FIG. 3 in which the post is oriented at an inclination of approximately 5 to 10° from vertical. Engagement of a lower end of the mounting sleeve below the beam acts as a stop which prevents further outward pivoting movement of the post.

A base plate 56 is similarly provided along the beam at the left hand side. The base plate 56 extends in the longitudinal direction in an upright orientation spaced from the inner side of the beam in alignment with respective inner ends of the notches 52 so that the posts of the left hand side are abutted against the base plate along the outer side thereof when pinned in the vertical orientation. The base plate 56 in the illustrated embodiment has a height in the order of approximately 3 inches so as to be sufficient for gripping the bottom edge of a bale which has recently been deposited on the deck by a suitable lifting fork so that when the lifting forks are withdrawn from the bale the bale remains secured on the deck and is prevented from outward sliding movement relative to the deck by the base plate 56.

All of the posts 36 include cleats 57 supported thereon for gripping the bales carried on the deck. Each cleat comprises an elongate pointed plate member pivotally secured to the post at a vertically spaced position from other cleats on the same post. Suitable stops 58 are provided on the posts to prevent downward pivotal movement of the cleats from a horizontal engaged position without restricting upward pivoting movement from the horizontal engaged position to a vertical release position alongside the post. A spring 60 biases the cleat downward into the horizontal and engaged position extending inwardly from the post for being engaged into a bale. Vertical spacing of the cleats on each post corresponds to the spacing of the rows of the bales supported on the deck so that a cleat is provided for each row of bales. After a clamping force has been released from the side portions for subsequent unloading and the bales are lifted upwardly with a loader, the cleats automatically release from the bale due to their upward pivoting movement to the release position alongside the posts.

Rear posts 62 are provided along the rear edge of the deck 12 to secure the load from the rear. The rear posts are similarly supported in respective mounting sleeves 64 which permit the posts to be selectively and slidably removed therefrom as desired. Locking pins 66 selectively secure the posts within the sleeves when received through cooperating apertures in the posts and sleeves. When arranged for bales having a four foot width, the posts are provided at a four foot spacing in which one of the posts is centered with respect to a middle row of bales while the outer posts are centered with outer rows of the bales.

Push plates 68 are provided along the rear of the deck and along the outer sides of the beams 26 for engagement by a loader to provide a pushing force thereon when desired. The push plates 68 each comprise a piece of flat iron secured between adjacent posts at an outer side thereof so that the side portions can be pushed inwardly by a loader when aligning or loading the bales or a loader can apply a pushing force to the trailer from the rear when the trailer is settled in the ground during loading.

An actuator mechanism is provided below the deck to provide a clamping force to the side portions which urges the side portions inwardly towards one another for clamping the bales loaded therebetween. The actuator generally comprises a winch 70 which is coupled to the side portions by suitable pulleys 72 and a cable 74 coupled therebetween. Each beam 26 of the side portions includes a pair of the pulleys 72 mounted thereon at longitudinally spaced positions spaced laterally inwardly by a suitable link member 76. The link members 76 position the pulleys spaced inwardly from the beams so that the pulleys remain sheltered below the deck even when the beams are at their furthermost outward position relative to the deck. The cable 74 is fixedly anchored to the deck 12 at the front end opposite the winch 70 and then extends about the pulleys 72 from the front end to the rear end of the deck in a zigzag pattern so as to alternate from a pulley 72 on one side portion to a pulley on the opposing side portion. The winch 70 is driven by a hydraulic motor which applies a constant pressure when actuated for wrapping or winding the cable on the winch so as to shorten the distance between the pulleys 72 of the opposing side portions, thus drawing the side portions inwardly. Even once the side portions are drawn inwardly to engage opposing sides of the load, continued pressure is applied so that a continued clamping force is applied to the load by the inward pressure on the side portions. This clamping force adequately secures the load along the full length thereof for safe transport without strapping the load.

In order to load the device 10, the winch 70 is first loosed to release the clamping force of the actuator. The posts 36 along the left hand side comprising the loading side are removed from the respective sleeves to provide access to the deck by a loader supporting bales thereon. The spacing limiter 44 at the right hand side is adjusted and secured at a selected spacing of the beam from the deck. When carrying large square bales this may correspond to setting the spacing between the side portions to 8 feet or 12 feet from one another depending upon whether 2 or 3 rows of bales are desired. When 3 rows are desired, the spacing limiter 44 is set at a 2 foot spacing of the right hand side portion relative to the deck as the deck typically has an 8 foot width.

Once bales are deposited on the deck, the loader is retracted while the bales remain caught by the base plate 56 to a main engaged on the deck. As further bales are loaded in additional rows, previously deposited rows are pushed against the right hand side to push the side portion along the right hand side outwardly to its maximum spacing as determined by the spacing limiter 44. As the bales are pushed against the posts along the right hand side, the cleats which are biased into the horizontal position automatically engage into the bales pushed there against. The bales are loaded in an orientation to extend in a longitudinal direction of the trailer in their longest dimension so that 4 rows of bales are permitted in the longitudinal direction when using a 32 foot long deck. In this orientation two posts at a 4 foot spacing are arranged to overlap each row of bales in the longitudinal direction.

Once all of the bales are loaded in place, the mounting sleeves along the left hand side are pivoted outwardly and then the posts can readily be inserted therein. The posts are then pivoted into a vertical orientation either manually or with the assistance of the loader as may be desired at which point the posts are pinned in their vertical orientation. The biasing of the cleats on the left hand side also permits the cleats to be automatically engaged into the bales. A loader may push against the push plates 68 to assist in aligning and compacting the bales loaded onto the trailer. Actuation of the winch 70 shortens the cable 74 woven in an alternating pattern between the pulleys 72 of the opposing side portions to thus pull the side portions inwardly and provide a clamping force at opposing sides of the load.

With the posts pinned in place, the clamping force slidably displaces the posts of the side portions inwardly while maintaining them in the vertical orientation so that the lateral spacing at the deck height and along the full length of the side portions in the longitudinal direction is commonly adjusted to match the width of the load.

For subsequent unloading, the winch 70 of the actuator mechanism is loosened and posts of one or both sides of the deck are removed. When some of the posts remain engaged, the bales can readily be lifted off the deck once the clamping force is released due to the unrestricted upward pivoting movement of the cleats which automatically release when the bales are lifted upwardly with a loader.

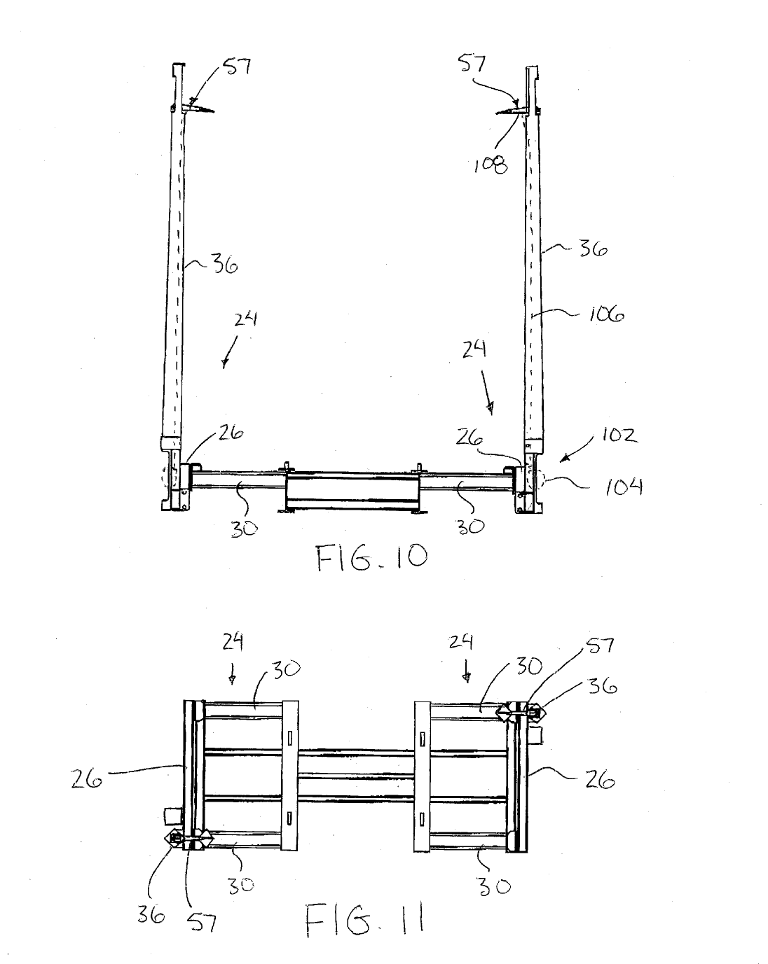

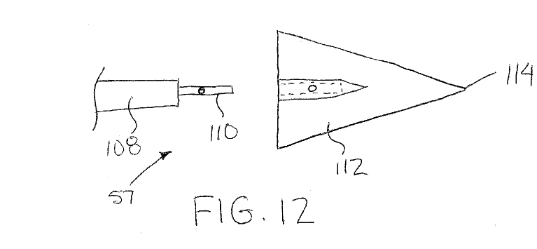

Turning now to FIGS. 8 through 12, a further embodiment of the side portions 22 described in which two opposed sections 24 are illustrated for mounting beneath the deck of the trailer in place of the sections 24 shown in the previous embodiment. Each of the sections 24 according to the second embodiment span in the longitudinal direction a distance typically of approximately four feet and accordingly many more sections 24 are provided along the length of the deck in a preferred arrangement according to the second embodiment as compared to the previous embodiment noted above.

Similarly to the previous embodiment, each section 24 comprises a beam 26 upon which the posts 36 are mounted. The beams are supported similarly to the previous embodiment to be moveable in a generally horizontal direction with the posts 36 thereon. The beams 26 are each supported at longitudinally opposing ends on telescoping arms 28 extending in the lateral direction of movement to be received within respective mounting sleeves 30 arranged to be supported beneath the deck on the trailer frame, so as to also function similarly to the previous embodiment.

The mounting sleeves 30 according to the second embodiment comprise two separate sleeves on opposed lateral sides of the trailer at each mounting locating of the telescoping arms 28 as opposed to a single common sleeve extending between the opposing sides as in the previous embodiment.

The posts 36 are hinged to the beams 36 and can be secured in an upright and vertical orientation in the same manner as described above with regard to the first embodiment. Pivoting movement of the posts, between a released position extending at an upward and outward incline and an in use position in which the posts are locked in a vertical orientation, can be accomplished by an actuator or by manually displacing the posts as in the previous embodiment. The posts on one or both sides of the trailer may be configured for such pivotal movement between released and in use positions.

Also as in the previous embodiment, the posts 36 are provided with cleats 57, but only a single cleat is provided on each post adjacent the upper free end of the post in this instance. The posts in this instance each comprise a hollow tubular member having an elongate channel opening 100 formed therein adjacent the upper free end which extend through the post from the inner two outer sides thereof. Each cleat 57 is mounted within the channel opening 100 of the respective post 36 with the cleat being pivotal about an axis extending horizontally, generally in the longitudinal direction of the trailer. Each cleat is pivotally supported on the post at a lower rear end of the cleat such that the cleat is pivotal between a released position extending upwardly substantially alongside the post through the channel opening 100 and an engaged position in which the cleat projects laterally inwardly in a near horizontal configuration. The pivot location of the cleats 57 is at the outer side of the posts so that the cleat extends through channel opening in the post and such that a bottom end of the channel opening 100 at the inner side of the post acts as an effective stop 58 for preventing further downward horizontal pivoting movement beyond a horizontal orientation of the cleat in the engaged position.

An actuator 102 is provided in association with each of the cleats 57 to provide a downward clamping force from the released position to the in-use and substantially horizontal position of the cleat. In the exemplary embodiment the actuator 102 comprises a winch mechanism 104 supported on the beam 26 adjacent the base of the respective posts 36. The winch is connected to the respective cleat 57 by a suitable tether or winch cable 106 which can be arranged to extend through the hollow post 36 for connection to the cleat 57 spaced inwardly along the cleat from the pivot towards the free end thereof. Accordingly when tension is applied to the winch cable 106 by the winch 104, the respective cleat 57 is urged downwardly from the released position to the engaged position.

Two different versions of the cleats 57 according to the second embodiment are shown in FIGS. 9 and 12 respectively. In each instance the cleat comprises a main stem portion 108 pivoted on the post 36 and which extends towards the free end locating a narrower spike portion 104 thereon. A suitable head 112 is mounted selectively on the spike 110 by inserting the spike 110 into a corresponding socket on the head 112. A set screw may be inserted through cooperating apertures in the socket of the head and the spike 110 for selectively securing the head 112 in place on the stem of the cleat. The different styles of heads 112 may be interchanged with one another or completely removed for use of the spike 110 by itself depending upon the compactness of the bale into which the cleat is engaged. The cleat may also be replaced with other suitable clamping elements when supporting other loads on the trailer deck.

In both embodiments, the head 112 of the cleat comprises a plate having a broad engaging surface which spans generally in the longitudinal direction of the trailer outward from opposing sides of the spike 110. The broad surface of the plates in each instance are oriented to be generally in a common plane with the stem 108 of the cleats so as to be generally horizontal in the engaged position while being generally upright in the released position.

In the embodiment of FIG. 9, the plate is generally diamond shaped with respect to the stem to define two opposing wing portions tapering laterally outwardly relative to the stem to respective opposed lateral apexes. The plate also tapers to an apex 114 towards the free end opposite the stem.

In the embodiment of FIG. 12, the plate is generally triangular in shape so as to be broader in the lateral direction at the base thereof where it is mounted onto the stem. The plate of FIG. 12 thus similarly tapers inwardly towards the apex 114 at the free end of the plate opposite the stem 108 of the cleat.

In use, the opposed sections 24 of the side portions of the trailer, according to the second embodiment shown in FIG. 8, function similarly to the previous embodiment. In order to load the trailer, the sections 24 are first slid outwardly away from those of the opposing side of the trailer to maximize the width between the opposing pairs of posts 36. The posts may further be pivoted into the respective released positions extending upwardly at an outward incline. Once objects, for example bales, are loaded onto the deck, the posts are fixed in a vertical orientation and then slid inwardly so that the opposing sections 24 of the side portions are urged towards one another by the appropriate actuator which clamps the load between the opposing side portions of the trailer.

The cleats 57 in the second embodiment are preferably maintained in an upright and released orientation until the posts 36 clamp the bales therebetween at a minimum lateral spacing therebetween. The actuators 102 of the respective cleats can then be activated to provide a downward clamping force to the cleats so that the cleats penetrate into the load and provide some downward pressure to maintain to load secured to the deck surface as well. The actuator of the cleats is arranged to provide sufficient downward pressure that the downward clamping force is in a range which exceeds at least 20 percent of the weight of the load when transporting bales for instance.

In yet further embodiments, posts with cleats 57 according to the second embodiment may also be provided at the front and rear ends of the trailer so as to provide additional downward clamping force to the load. Although the posts in the embodiment of FIG. 8 are shown offset from one another in the longitudinal direction, in preferred embodiments, the posts 36 on opposing sides of the trailer may be aligned with one another in respective pairs along the length of the trailer deck.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A load transport device comprising:
a deck which is elongate in a longitudinal direction and which is supported for rolling movement along the ground in the longitudinal direction;
side portions extending in the longitudinal direction in an upright orientation along opposing sides of the deck, the side portions being supported for movement relative to one another in a lateral direction, transversely to the longitudinal direction of the deck such that a horizontal spacing between the side portions is adjustable to accommodate various load sizes; and
an actuator for applying a clamping force to the side portions to urge the side portions towards one another for clamping a load between the side portions.

2. The device according to claim 1 wherein the side portions remain in a substantially vertical orientation as the side portions are displaced in the lateral direction.

3. The device according to claim 1 wherein the side portions are supported for substantially horizontal sliding movement in the lateral direction.

4. The device according to claim 1 wherein the side portions are supported for sliding movement in the lateral direction by telescoping members.

5. The device according to claim 1 wherein a horizontal spacing between the side portions at a height of the deck is adjusted along a length of the side portions in the longitudinal direction as the side portions are displaced in the lateral direction relative to one another.

6. The device according to claim 1 wherein the deck comprises a flat deck and wherein the side portions are movable in a horizontal direction relative to the deck.

7. The device according to claim 1 wherein the deck comprises a flat deck and wherein the side portions include an upper supporting surface in substantially horizontal alignment with the deck in which the supporting surfaces of the side portion are movable relative to one another with the respective side portions.

8. The device according to claim 1 wherein the side portions are movable relative to the deck and wherein there is provided a spacing limiter on at least one of the side portions which only restricts movement of the respective side portion outwardly away from the deck.

9. The device according to claim 1 wherein each side portion comprises a plurality of posts spaced in the longitudinal direction and being commonly movable in the lateral direction.

10. The device according to claim 9 wherein the posts along at least one side portion are selectively removable.

11. The device according to claim 9 wherein the posts along at least one side portion are supported for selected pivotal movement in addition to being slidable in the lateral direction.

12. The device according to claim 1 wherein each side portion comprises a plurality of sections which are movable independently of one another.

13. The device according to claim 1 wherein each side portion comprises a plurality of posts spaced apart in the longitudinal direction and an upright base plate spanning between the posts along a bottom end thereof.

14. The device according to claim 1 wherein each side portion comprises a plurality of posts spaced apart in the longitudinal direction and wherein each post includes at least one cleat supported thereon.

15. The device according to claim 14 wherein the cleats are pivotal between an engaged position projecting laterally inwardly and a release position extending in an upward direction substantially alongside the respective post.

16. The device according to claim 15 wherein the cleats are biased into the engaged position.

17. The device according to claim 14 wherein each cleat including an actuator associated therewith which is arranged to apply a downward clamping force to the cleat.

18. The device according to claim 17 wherein each cleat includes a broad engaging surface spanning generally in the longitudinal direction of the deck and tapering inwardly towards an apex at a free end of the cleat.

19. The device according to claim 1 wherein the actuator comprises a hydraulic actuator which maintains a clamping force by maintaining hydraulic pressure acting to urge the side portions laterally inward toward one another.

20. The device according to claim 1 wherein the actuator comprises a winch winding a cable thereon in which the cable is woven in alternating pattern between pulleys on opposing side portions for displacing the side portions towards one another in the lateral direction as the cable is shortened by winding on the winch.
